(19) United States
(12) Patent Application Publication
(10) Pub. No.: US 2026/0341241 A1
(43) Pub. Date: Oct. 29, 2026

(54) LAMP AND SCREEN LAMP

(71) Applicant: QISDA CORPORATION, Taoyuan City (TW)

(72) Inventors: CHAO-SHUN YU, Taoyuan City (TW); WEN-CHANG CHEN, Taoyuan City (TW); CHUN-SHENG HU, Taoyuan City (TW)

(21) Appl. No.: 19/651,805

(22) Filed: Apr. 20, 2026

(30) Foreign Application Priority Data
Apr. 24, 2025 (TW) 114115432

(51) Int. Cl. G09G 3/34; F21S 10/06; F21V 23/04; F21V 33/00

(52) U.S. Cl. CPC G09G 3/3406; F21S 10/066; F21V 23/0442; F21V 33/0052; G09G 2320/0233; G09G 2320/0261; G09G 2320/0646; G09G 2360/02

(57) ABSTRACT

A lamp is configured to be disposed corresponding to a viewable region of a screen, and includes a lighting module, a light sensor electrically coupled to the lighting module, and a controller electrically coupled to the lighting module and the light sensor. The lighting module is configured to emit a lamp light. The light sensor is configured to receive a screen light emitted from the screen for enabling the controller to determine whether the screen is in a normal display mode or a strobing display mode. When the screen is in the strobing display mode, the controller drives the lighting module to switch to a fill lighting mode for enabling the lamp light to have a fill light strobing frequency that is equal to a strobing frequency of the screen light and a brightness that is in complementarity with a brightness of the screen light.

### CROSS-REFERENCE TO RELATED PATENT APPLICATION

This application claims the benefit of priority to Taiwan Patent Application No. 114115432, filed on Apr. 24, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a lamp, and more particularly to a lamp and a screen lamp each having two display modes.

### BACKGROUND OF THE DISCLOSURE

When a conventional screen is in operation, the conventional screen may flicker from time to time, which may cause eye discomfort to the user. Specifically, the flickering of the conventional screen may result in a risk of causing the following conditions: headaches, eyestrain, photosensitive epilepsy, decreased vision, distraction, or autism.

### SUMMARY OF THE DISCLOSURE

In response to the above-referenced technical inadequacies, the present disclosure provides a lamp and a screen lamp for effectively improving on the issues associated with conventional screens.

In order to solve the above-mentioned problems, one of the technical aspects adopted by the present disclosure is to provide a screen lamp for being hung on a top portion of a screen. The screen lamp includes a lighting module, a light sensor, and a controller. The lighting module is configured to emit a lamp light toward a predetermined region that is at least partially overlapped with a viewable region of the screen. The lighting module is selectively switchable between a non-fill light state and a fill light state. The light sensor is configured to face toward the screen and to receive a screen light emitted from the screen. The controller is electrically coupled to the lighting module and the light sensor. The controller is configured to determine whether the screen is in a normal display mode or in a strobing display mode by receiving signals of the light sensor related to the screen light. When the controller determines that the screen is in the strobing display mode, the controller drives the lighting module to switch to the fill light state so as to enable the lamp light to have a fill light strobing frequency that is equal to a strobing frequency of the screen light and a brightness that is in complementarity with a brightness of the screen light.

In order to solve the above-mentioned problems, another one of the technical aspects adopted by the present disclosure is to provide a lamp for corresponding in position to a viewable region of a screen. The lamp includes a lighting module, a light sensor, and a controller. The lighting module is configured to emit a lamp light toward a predetermined region that is at least partially overlapped with the viewable region. The lighting module is selectively switchable between a non-fill light state and a fill light state. The light sensor is configured to receive a screen light emitted from the screen. The controller is electrically coupled to the lighting module and the light sensor. The controller is configured to determine whether the screen is in a normal display mode or in a strobing display mode by receiving signals of the light sensor related to the screen light. When the controller determines that the screen is in the strobing display mode, the controller drives the lighting module to switch to the fill light state so as to enable the lamp light to have a fill light strobing frequency that is equal to a strobing frequency of the screen light and a brightness that is in complementarity with a brightness of the screen light.

In order to solve the above-mentioned problems, yet another one of the technical aspects adopted by the present disclosure is to provide a lamp that corresponds in position to a viewable region of a screen. The screen is electrically coupled to a screen control unit and is configured to emit a screen light. The lamp includes a lighting module and a controller. The lighting module is configured to emit a lamp light toward a predetermined region that is at least partially overlapped with the viewable region. The lighting module is selectively switchable between a non-fill light state and a fill light state. The controller is electrically coupled to the lighting module. The controller is configured to be electrically coupled to the screen control unit so as to determine whether the screen is in a normal display mode or in a strobing display mode by receiving signals of the screen control unit related to the screen light. When the controller determines that the screen is in the strobing display mode, the controller drives the lighting module to switch to the fill light state so as to enable the lamp light to have a fill light strobing frequency that is equal to a strobing frequency of the screen light and a brightness that is in complementarity with a brightness of the screen light.

Therefore, the lamp and the screen lamp in the present disclosure can be configured to provide fill light relative to the screen light by operating the lamp light at the fill light strobing frequency when the screen is in the strobing display mode, thereby effectively reducing the discomfort caused to the user in the strobing display mode.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a lamp being a screen lamp according to a first embodiment of the present disclosure;

FIG. 2 is a schematic side view of the lamp of FIG. 1;

FIG. 3 is a schematic perspective view of the lamp being a desk lamp according to the first embodiment of the present disclosure;

FIG. 4 is a functional block diagram of the lamp and a screen according to the first embodiment of the present disclosure;

FIG. 5 is a brightness diagram showing the lamp in a fill light state and the screen in a strobing display mode according to the first embodiment of the present disclosure;

FIG. 6 is a brightness diagram showing the lamp at the fill light state and the screen in the strobing display mode according to a second embodiment of the present disclosure;

FIG. 7 is a schematic side view of the lamp according to a third embodiment of the present disclosure;

FIG. 8 is a functional block diagram showing a first configuration of the lamp, the screen, and a screen control unit according to the third embodiment of the present disclosure;

FIG. 9 is a functional block diagram showing a second configuration of the lamp, the screen, and the screen control unit according to the third embodiment of the present disclosure; and

FIG. 10 is a functional block diagram showing a third configuration of the lamp, the screen, and the screen control unit according to the third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

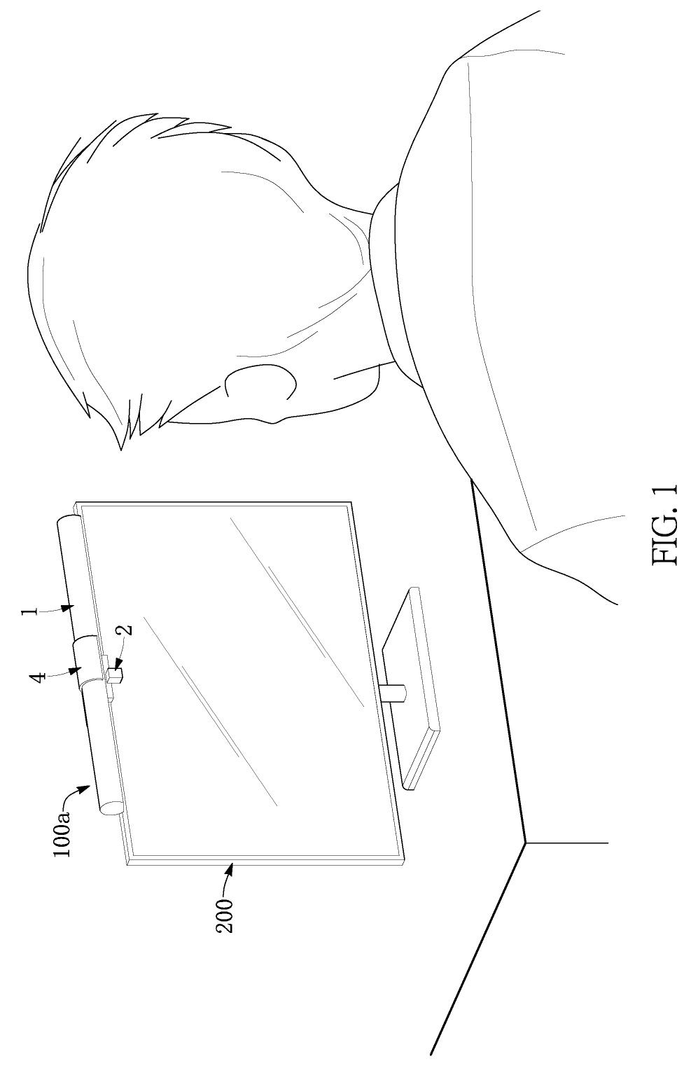

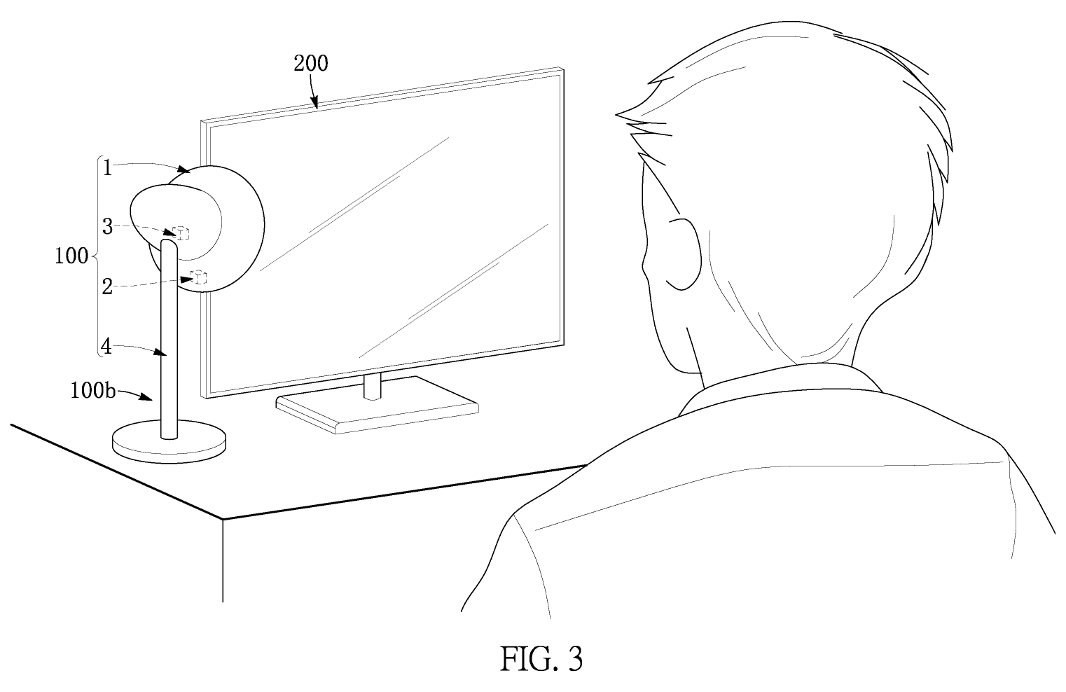

Referring to FIGS. 1-5 , a first embodiment of the present disclosure is provided. The present embodiment provides a lamp 100 for corresponding in position to a viewable region 202 of a screen 200. The lamp 100 can be a screen lamp 100a, a desk lamp 100b, a mood lamp (not shown in the drawings), or other lamps (e.g., a table lamp or a floor lamp). In order to clearly describe the lamp 100 of the present embodiment, the following description describes the screen lamp 100a for being hung on a top portion of the screen 200, but the present disclosure is not limited thereto.

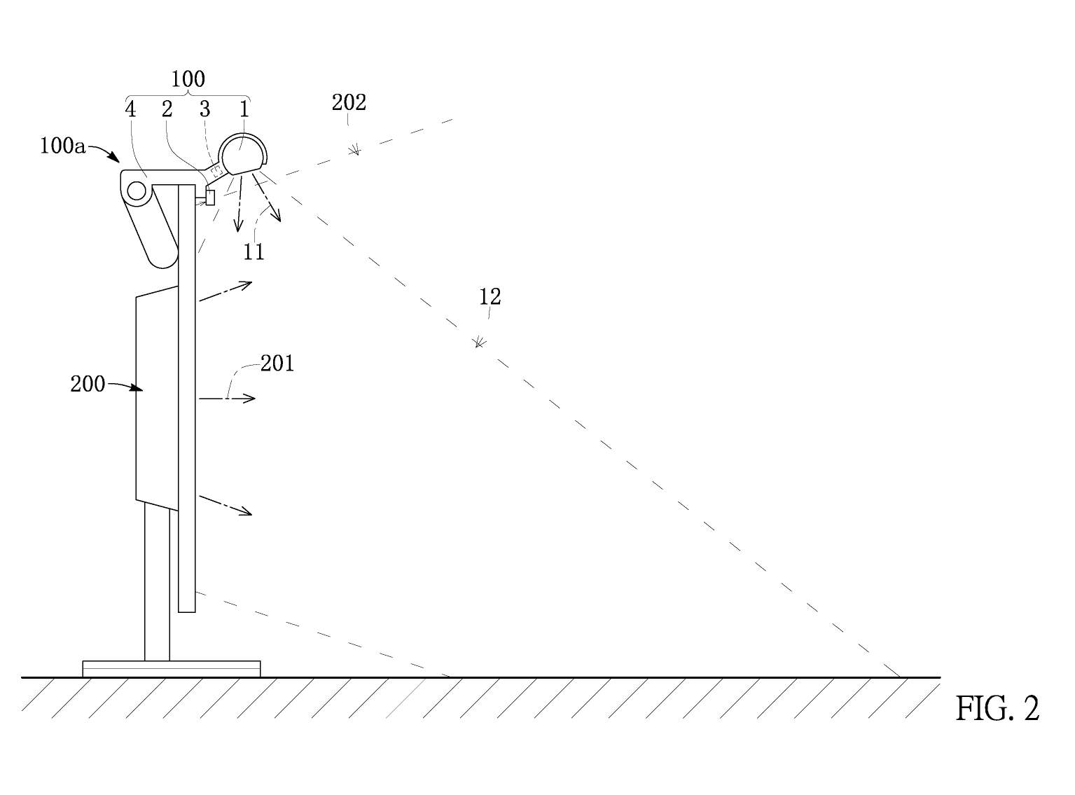

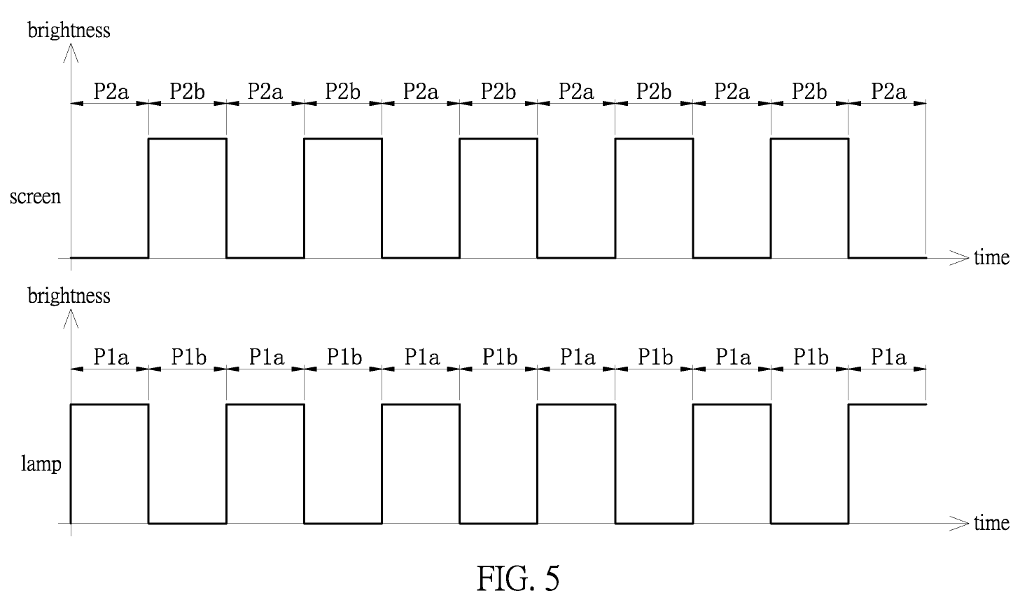

It should be noted that the size and type of the screen 200 can be adjusted or changed according to practical requirements; for example, the screen 200 can be a television, a monitor connected to a desktop computer, a laptop monitor, or a touch tablet. Moreover, the screen 200 is configured to emit a screen light 201 and defines a viewable region 202, and a display mode of the screen 200 can be defined as a normal display mode (as shown in FIG. 2) or a strobing display mode (as shown in FIG. 5) according to a continuity of the screen light 201.

Specifically, when the screen 200 is in the normal display mode, the screen light 201 (or the display of the screen 200) is continuous and does not produce flickering. When the screen 200 is in the strobing display mode, the screen light 201 (or the display of the screen 200) may flicker periodically or non-periodically (e.g., a black screen), and may be discontinuous. For example, the strobing display mode can be a motion blur reduction (MBR) display mode.

The following description describes the configuration of the screen lamp 100a, and then describes the connection relationship of the screen lamp 100a and the screen 200. The power required for the operation of the screen lamp 100a can be provided by a built-in battery and/or by connecting to an external power source (e.g., a mains socket or a mobile power supply). The screen lamp 100a in the present embodiment includes a lighting module 1, a light sensor 2, a controller 3 electrically coupled to the lighting module 1 and the light sensor 2, and a housing 4 that carries the above components, but the present disclosure is not limited thereto.

In the present embodiment, the screen lamp 100a can be hung on the top portion of the screen 200 through the housing 4, so that the lighting module 1 faces toward the viewable region 202 of the screen 200, and the light sensor 2 faces toward the screen 200. The term “hung” in the present embodiment can indicate the following implementations: the screen lamp 100a abuts against the top portion of the screen 200 without any external component, or the screen lamp 100a is fixed to the top portion of the screen 200 through an external component (e.g., at least one screw).

The lighting module 1 is configured to emit a lamp light 11 toward a predetermined region 12 that is at least partially overlapped with the viewable region 202 of the screen 200. In other words, the predetermined region 12 corresponds in position to a user viewing the screen 200, so that the lamp light 11 forms an ambient light for the user.

Moreover, the lighting module 1is selectively switchable between a non-fill light state (as shown in FIG. 2) and a fill light state (as shown in FIG. 5). The lighting module 1in the present embodiment is a straight-like structure and includes a plurality of light emitting diode (LED) chips, but the present disclosure is not limited thereto. For example, in other embodiments of the present disclosure not shown in the drawings, the lighting module 1 can be a curved structure.

The light sensor 2 in the present embodiment is closer to the screen 200 than the lighting module 1, and the light sensor 2 is configured to face toward the screen 200 and to receive the screen light 201 emitted from the screen 200. The light sensor 2can include a single sensing unit or a plurality of sensing units that are in a matrix arrangement according to practical requirements, thereby receiving the screen light 201 emitted from at least part of the screen 200. In practice, the light sensor 2can be disposed on a structural member of the screen lamp 100a that is assembled to the screen 200 (e.g., a clamping member, an abutting member, or a rotating shaft of the screen lamp 100a close to the screen 200); or, the light sensor 2 can be disposed independently and can transmit information to the controller 3 of the screen lamp 100a by a universal serial bus (USB) cable or a wireless transmission manner.

The controller 3 is configured to determine whether the screen 200 is in the normal display mode or in the strobing display mode by receiving signals of the light sensor 201 related to the screen light 201, thereby driving the lighting module 1 to switch to the non-fill light state or the fill light state.

When the controller 3 determines that the screen 200 is in the normal display mode, the controller 3 drives the lighting module 1 to switch to the non-fill light state so as to enable the lamp light 11 to have a fixed brightness. When the lighting module 1 is at the fill light state, a brightness of the lamp light 11 can be adjusted or changed according to practical requirements (e.g., a high brightness, a low brightness, or a zero brightness), but the present disclosure is not limited thereto.

Moreover, when the controller 3 determines that the screen 200 is in the strobing display mode, the controller 3 drives the lighting module 1 to switch to the fill light state so as to enable the lamp light 11 to have a fill light strobing frequency that is equal to a strobing frequency of the screen light 201 and the brightness that is in complementarity with a brightness of the screen light 201.

Specifically, when the controller 3 determines that the screen 200 is in the strobing display mode, the lamp light 11 has a lamp-on period P1a and a lamp-off period P1b. The lamp-on period P1a corresponds to a black-screen period P2a of the screen light 201, and the lamp-off period P1b has a brightness of zero and corresponds to a bright-screen period P2b of the screen light 201. The brightness of the lamp light 11 in the lamp-on period P1a can be adjusted or changed according to practical requirements. In other words, the term “complementarity” in the present embodiment is not limited by using the lamp light 11 to completely complement a brightness difference of the screen light 201 between the bright-screen period P2b and the black-screen period P2a.

For example, the lamp light 11 in the lamp-on period P1a and the screen light 201 in the black-screen period P2a jointly have a fill light brightness, the lamp light 11 in the lamp-off period P1b and the screen light 201 in the bright-screen period P2b jointly have a display brightness, and the fill light brightness is within a range from 80% to 120% of the display brightness.

It should be noted that, when the lamp 100 is provided in types other than the screen lamp 100a (e.g., the desk lamp 100b or the mood lamp), the lamp 100 has the lighting module 1, the light sensor 2, and the controller 3, and can be configured to realize corresponding functions. In other words, the difference between the desk lamp 100b (or the situation lamp) and the screen lamp 100a mainly resides in the specific arrangement relative to the screen 200.

In summary, the lamp 100 (e.g., the screen lamp 100a) in the present embodiment is configured to provide fill light relative to the screen light 201 by operating the lamp light 11 at the fill light strobing frequency when the screen 200 is in the strobing display mode, thereby effectively reducing the discomfort caused to the user in the strobing display mode.

Moreover, the lamp 100 (e.g., the screen lamp 100a) in the present embodiment is provided with the above fill light function while maintaining the existing lighting function, thereby increasing an added value of the lamp 100 (e.g., the screen lamp 100a) and eliminating the need for the user to purchase other devices due to the screen 200 having a strobing phenomenon.

### Second Embodiment

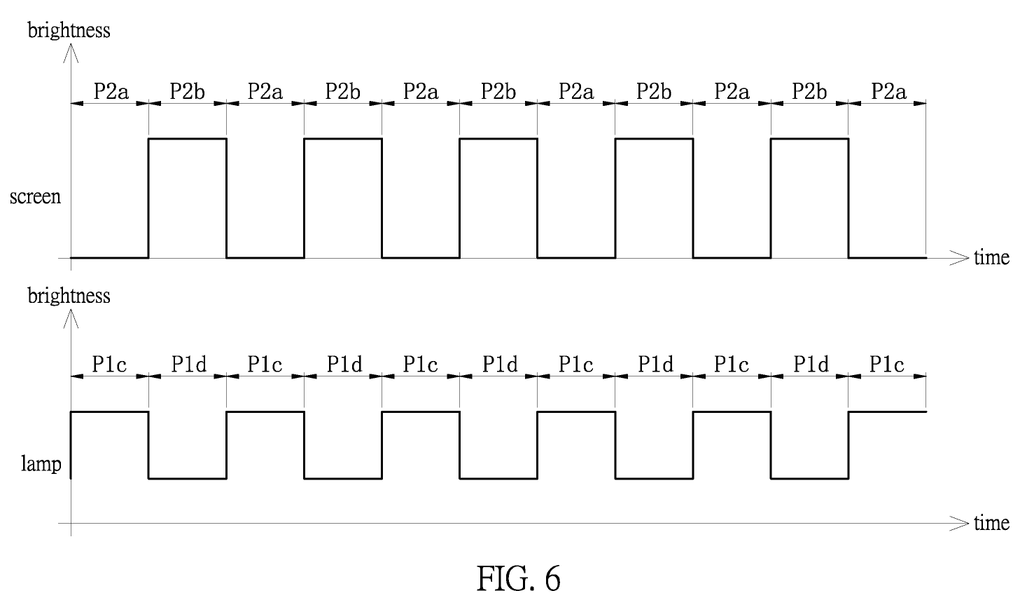

Referring to FIG. 6, a second embodiment of the present disclosure, which is similar to the first embodiment of the present disclosure, is provided. For the sake of brevity, descriptions of the same components in the first and second embodiments of the present disclosure will be omitted herein, and the following description only discloses different features between the first and second embodiments.

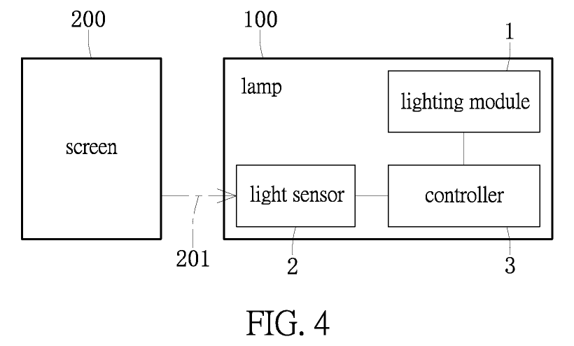

Referring to FIG. 6 and further referring to FIGS. 2 and 4 , when the controller 3 determines that the screen 200 is in the strobing display mode, the lamp light 11 has a high-brightness period P1c and a low-brightness period P1d having a brightness less than that of the high-brightness period P1c. The high-brightness period P1c corresponds to the black-screen period P2a of the screen light 201, and the low-brightness period P1d corresponds to the bright-screen period P2b of the screen light 201. The brightness of the lamp light 11 in the low-brightness period P1d can be less than 50% of the brightness of the lamp light 11 in the high-brightness period P1c, and is not zero.

Specifically, the lamp light 11 in the high-brightness period P1c and the screen light 201 in the black-screen period P2a jointly have a fill light brightness, the lamp light 11 in the low-brightness period P1d and the screen light 201 in the bright-screen period P2b jointly have a display brightness, and the fill light brightness is within a range from 80% to 120% of the display brightness.

In addition, the brightness change of the lamp light 11 between the high-brightness period P1c and the low-brightness period P1d can be implemented by simultaneously changing brightness of the LED chips of the lighting module 1 or by adjusting a quantity of the LED chips of the lighting module 1 that emit light, but the present disclosure is not limited thereto.

### Third Embodiment

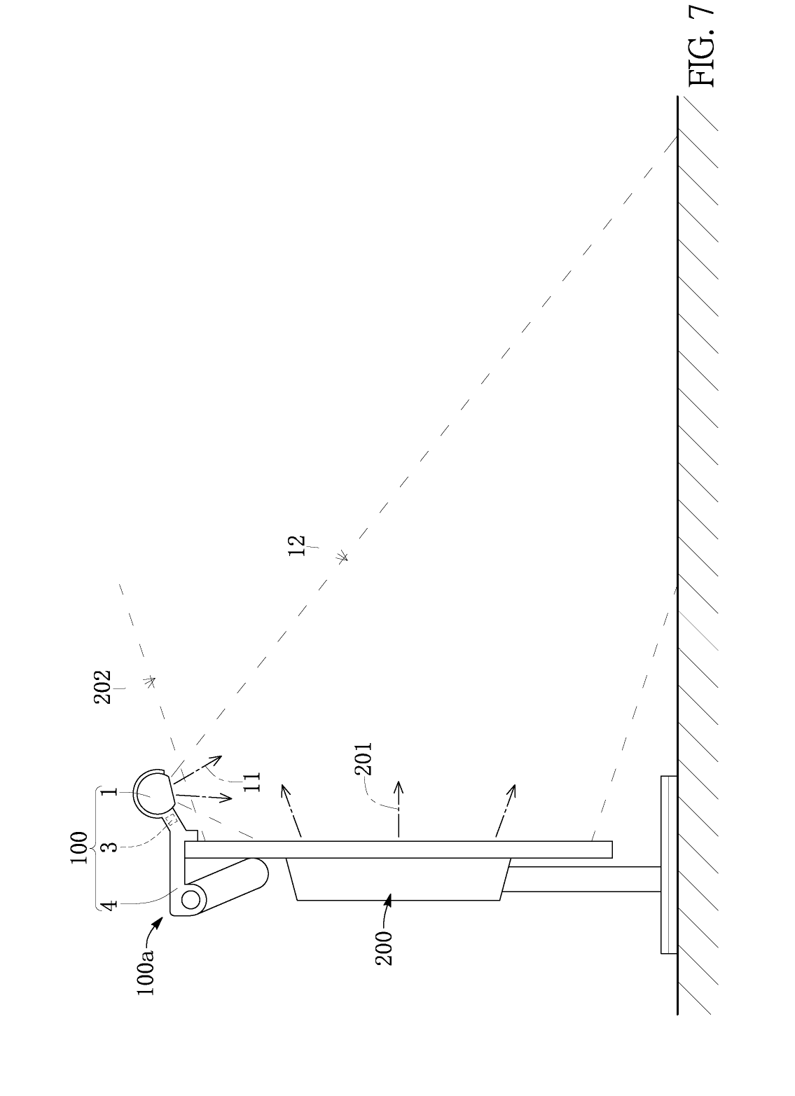

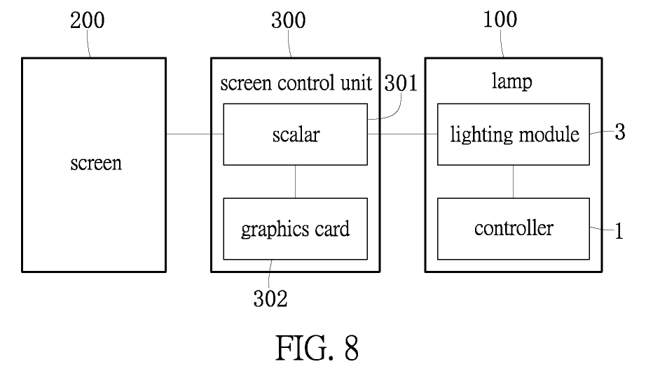

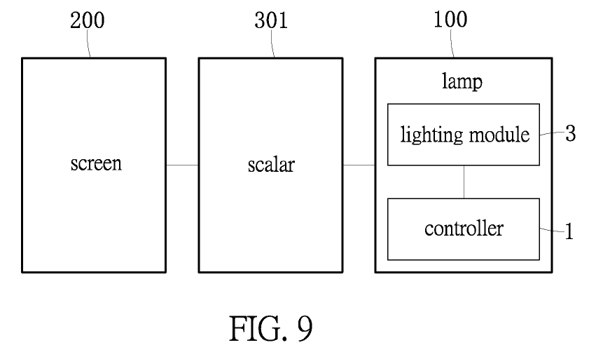

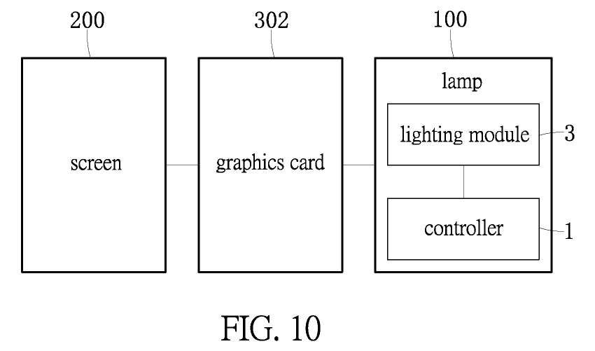

Referring to FIGS. 7-10, a third embodiment of the present disclosure, which is similar to the first and second embodiments of the present disclosure, is provided. For the sake of brevity, descriptions of the same components in the first to third embodiments of the present disclosure will be omitted herein, and the following description only discloses different features between the third embodiment and the first and second embodiments.

In the present embodiment, the lamp 100 is provided to correspond in position to a viewable region 202 of a screen 200, and the screen 200 is electrically coupled to a screen control unit 300 and is configured to emit a screen light 201. The screen 200 of the present embodiment is substantially identical to that of the first and second embodiments, and is not described again for the sake of brevity.

Moreover, the screen control unit 300 is disposed inside of or outside of the screen 200, and is configured to control the screen 200 to display. In the present embodiment, the screen control unit 300 includes at least one of a scalar 301 and a graphics card 302, and the screen control unit 300 is connected to the lamp 100 through at least one cable or a wireless connection manner, but the present disclosure is not limited thereto.

The lamp 100 in the present embodiment can be a screen lamp 100a, a desk lamp (not shown in the drawings), or a mood lamp (not shown in the drawings), and the lamp 100 includes a lighting module 1 and a controller 3 that is electrically coupled to the lighting module 1. It should be noted that, when the lamp 100 is the screen lamp 100a, the arrangement of the lamp 100 (e.g., the screen lamp 100a is hung on the top portion of the screen 200) and the description of the lighting module 1 of the present embodiment are substantially identical to those of the first and second embodiments, and are not described again for the sake of brevity.

The controller 3 is configured to be electrically coupled to the screen control unit 300 so as to determine whether the screen 200 is in a normal display mode or in a strobing display mode by receiving signals of the screen control unit 300 related to the screen light 201, thereby driving the lighting module 1 to switch to the non-fill light state or the fill light state.

It should be noted that, when the controller 3 determines that the screen 200 is in the normal display mode or in the strobing display mode, a corresponding operation of the lamp 100 in the present embodiment is substantially identical to that of the first and second embodiments, and is not described again for the sake of brevity.

### Beneficial Effects of the Embodiments

In conclusion, the lamp and the screen lamp in the present disclosure can be configured to provide fill light relative to the screen light by operating the lamp light at the fill light strobing frequency when the screen is in the strobing display mode, thereby effectively reducing the discomfort caused to the user in the strobing display mode.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A screen lamp for being hung on a top portion of a screen, the screen lamp comprising:
a lighting module configured to emit lamp light toward a predetermined region that is at least partially overlapped with a viewable region of the screen, wherein the lighting module is selectively switchable between a non-fill light state and a fill light state;
a light sensor configured to face toward the screen and to receive a screen light emitted from the screen; and
a controller electrically coupled to the lighting module and the light sensor, wherein the controller is configured to determine whether the screen is in a normal display mode or in a strobing display mode by receiving signals of the light sensor related to the screen light;
wherein, when the controller determines that the screen is in the strobing display mode, the controller drives the lighting module to switch to the fill light state so as to enable the lamp light to have a fill light strobing frequency that is equal to a strobing frequency of the screen light and a brightness that is in complementarity with a brightness of the screen light.

2. The screen lamp according to claim 1, wherein, when the controller determines that the screen is in the normal display mode, the controller drives the lighting module to switch to the non-fill light state so as to enable the lamp light to have a fixed brightness.

3. The screen lamp according to claim 1, wherein, when the controller determines that the screen is in the strobing display mode, the lamp light has:
a lamp-on period corresponding to a black-screen period of the screen light; and
a lamp-off period having a brightness of zero and corresponding to a bright-screen period of the screen light.

4. The screen lamp according to claim 3, wherein the lamp light in the lamp-on period and the screen light in the black-screen period jointly have a fill light brightness, and the lamp light in the lamp-off period and the screen light in the bright-screen period jointly have a display brightness, and wherein the fill light brightness is within a range from 80% to 120% of the display brightness.

5. The screen lamp according to claim 1, wherein, when the controller determines that the screen is in the strobing display mode, the lamp light has:
a high-brightness period corresponding to a black-screen period of the screen light; and
a low-brightness period having a brightness less than that of the high-brightness period and corresponding to a bright-screen period of the screen light.

6. The screen lamp according to claim 5, wherein the lamp light in the high-brightness period and the screen light in the black-screen period jointly have a fill light brightness, and the lamp light in the low-brightness period and the screen light in the bright-screen period jointly have a display brightness, and wherein the fill light brightness is within a range from 80% to 120% of the display brightness.

7. The screen lamp according to claim 1, wherein the strobing display mode is a motion blur reduction (MBR) display mode with periodic flickering.

8. A lamp for corresponding in position to a viewable region of a screen, the lamp comprising:
a lighting module configured to emit lamp light toward a predetermined region that is at least partially overlapped with the viewable region, wherein the lighting module is selectively switchable between a non-fill light state and a fill light state;
a light sensor configured to receive a screen light emitted from the screen; and
a controller electrically coupled to the lighting module and the light sensor, wherein the controller is configured to determine whether the screen is in a normal display mode or in a strobing display mode by receiving signals of the light sensor related to the screen light;
wherein, when the controller determines that the screen is in the strobing display mode, the controller drives the lighting module to switch to the fill light state so as to enable the lamp light to have a fill light strobing frequency that is equal to a strobing frequency of the screen light and a brightness that is in complementarity with a brightness of the screen light.

9. The lamp according to claim 8, wherein, when the controller determines that the screen is in the strobing display mode, the lamp light has:
a lamp-on period corresponding to a black-screen period of the screen light; and
a lamp-off period having a brightness of zero and corresponding to a bright-screen period of the screen light.

10. The lamp according to claim 9, wherein the lamp light in the lamp-on period and the screen light in the black-screen period jointly have a fill light brightness, and the lamp light in the lamp-off period and the screen light in the bright-screen period jointly have a display brightness, and wherein the fill light brightness is within a range from 80% to 120% of the display brightness.

11. The according to claim 8, wherein, when the controller determines that the screen is in the strobing display mode, the lamp light has:
a high-brightness period corresponding to a black-screen period of the screen light; and
a low-brightness period having a brightness less than that of the high-brightness period and corresponding to a bright-screen period of the screen light.

12. The lamp according to claim 11, wherein the lamp light in the high-brightness period and the screen light in the black-screen period jointly have a fill light brightness, and the lamp light in the low-brightness period and the screen light in the bright-screen period jointly have a display brightness, and wherein the fill light brightness is within a range from 80% to 120% of the display brightness.

13. A lamp for corresponding in position to a viewable region of a screen, the screen being electrically coupled to a screen control unit and being configured to emit a screen light, the lamp comprising:
a lighting module configured to emit a lamp light toward a predetermined region that is at least partially overlapped with the viewable region, wherein the lighting module is selectively switchable between a non-fill light state and a fill light state; and
a controller electrically coupled to the lighting module, wherein the controller is configured to be electrically coupled to the screen control unit so as to determine whether the screen is in a normal display mode or in a strobing display mode by receiving signals of the screen control unit related to the screen light;
wherein, when the controller determines that the screen is in the strobing display mode, the controller drives the lighting module to switch to the fill light state so as to enable the lamp light to have a fill light strobing frequency that is equal to a strobing frequency of the screen light and a brightness that is in complementarity with a brightness of the screen light.

14. The lamp according to claim 13, wherein the screen control unit includes at least one of a scalar and a graphics card.

15. The lamp according to claim 13, wherein, when the controller determines that the screen is in the normal display mode, the controller drives the lighting module to switch to the non-fill light state so as to enable the lamp light to have a fixed brightness.

16. The lamp according to claim 13, wherein, when the controller determines that the screen is in the strobing display mode, the lamp light has:
a lamp-on period corresponding to a black-screen period of the screen light; and
a lamp-off period having a brightness of zero and corresponding to a bright-screen period of the screen light.

17. The lamp according to claim 16, wherein the lamp light in the lamp-on period and the screen light in the black-screen period jointly have a fill light brightness, and the lamp light in the lamp-off period and the screen light in the bright-screen period jointly have a display brightness, and wherein the fill light brightness is within a range from 80% to 120% of the display brightness.

18. The lamp according to claim 13, wherein, when the controller determines that the screen is in the strobing display mode, the lamp light has:
a high-brightness period corresponding to a black-screen period of the screen light; and
a low-brightness period having a brightness less than that of the high-brightness period and corresponding to a bright-screen period of the screen light.

19. The lamp according to claim 18, wherein the lamp light in the high-brightness period and the screen light in the black-screen period jointly have a fill light brightness, and the lamp light in the low-brightness period and the screen light in the bright-screen period jointly have a display brightness, and wherein the fill light brightness is within a range from 80% to 120% of the display brightness.

20. The lamp according to claim 13, wherein the strobing display mode is a motion blur reduction (MBR) display mode.
